(19) United States
(12) Patent Application Publication
(10) Pub. No.: US 2005/0260906 A1
(43) Pub. Date: Nov. 24, 2005

(54) Fabric structure and its manufacturing method

(76) Inventor: Dong-Ho Chang, Gyeonggi-do (KR)

Correspondence Address: JONES DAY, 222 EAST 41ST ST, NEW YORK, NY, 10017, US

(21) Appl. No.: 10/902,667

(22) Filed: Jul. 29, 2004

(30) Foreign Application Priority Data
May 21, 2004 (KR) 10-2004-0036353

(51) Int. Cl. B32B 27/02; D03D 15/00; B32B 5/02

(52) U.S. Cl. 442/60; 139/420 R; 442/189; 442/217; 442/164; 442/59

(57) ABSTRACT

A fabric structure and its manufacturing method are disclosed. The fabric structure is weaved by wefts and warps which are crossed with each other, and each of wefts and warps has a double ply structure in which yarns thereof are contacted in a length direction. The fabric structure gives more excellent mechanical strength and better flexibility than a conventional one. Relatively thicker reinforced weft and warp are repeatedly inserted and weaved among common wefts and warps so as to form repeatedly protruded rectangular patterns on the surface of the fabric structure. The patterns increase a surface friction, thereby preventing accidents caused by slippery of the surface of the fabric structure.

### BACKGROUND OF THE INVENTION

1. Field of the Invention

The present invention relates to a fabric structure and its manufacturing method, and more particularly to a fabric structure made by weaving a plurality of wefts and warps to be crossed with each other, wherein weft and warp respectively have a double ply structure in which warp and weft are contacted in a length direction, and protruded rectangular patterns are repeatedly formed by inserting relatively thicker reinforced wefts and warps among a plurality of common wefts and common warps and then weaving them, and its manufacturing method.

2. Description of the Related Art

Generally, PE tarpaulin or PVC tarpaulin is commonly used as a textile for waterproof tent, sheltering cover, fabrics for temporary tent, isolating screen in a construction site, and the like.

Among them, PE tarpaulin is generally made by slitting and annealing an HDPE (High-Density Polyethylene) film to make a fabric, and then laminating an LDPE (Low-Density Polyethylene) resin on both surfaces of the fabric. Advantageously, PE tarpaulin does not contain a substance which causes environmental pollution during the manufacturing process, and it is relatively light and recyclable. However, PE tarpaulin has deficient flexibility and low mechanical strength, so its usage is restricted within a very narrow range.

In addition, since PE tarpaulin is apt to be slid by a slight external force due to the nature of the coated LDPE, it is difficult to load products packaged by the tarpaulin in several stages, and workers may be wounded due to its slippery surface.

In order to solve this problem, a tarpaulin in which LDPE resin is multi-coated on a layer weaved by HDPE was disclosed, and recently a method for making a tarpaulin by laminating LDPE resin on one or both surfaces of a layer weaved by HDPE and then extrusion-coating the layer with a cooling roller and a pressing roller was introduced. Such techniques may solve the aforementioned problem to some extent, but they cannot satisfy conditions that it should be more flexible and preserving as an industrial textile and keep a certain mechanical strength. In addition, the above techniques did not solve the problem of slippery.

Thus, researches and developments have been continuously conducted to solve the problems, and the present invention is designed from such technical aspects as a background.

### SUMMARY OF THE INVENTION

Therefore, an object of the present invention is to provide a fabric structure which is light, malleable and strong rather than a convention one, and is capable of preventing slippery while it is spread on a flat surface. In such an aspect, the present invention provides a fabric structure in which a plurality of wefts and warps are intersectionally weaved to have strong mechanical tenacity and good flexibility, and in which protruded rectangular patterns are repeatedly formed by inserting relatively thicker reinforced wefts and warps among a plurality of common wefts and common warps so as to increase a frictional force and thus prevent slippery.

In order to accomplish the above object, the present invention provides a fabric structure in which a plurality of wefts and warps are weaved to be crossed with each other, wherein each of common wefts and each of common warps, composing the plurality of wefts and warps, are contacted with each other in a length direction.

At this time, each of the common wefts and the common warps preferably has a double ply structure in which sides of yarns thereof are contacted in a length direction. More preferably, the plurality of wefts include a plurality of common wefts and one colored weft, repeatedly arranged in parallel, and the plurality of warps includes a plurality of common warps and one colored warp, repeatedly arranged in parallel.

Alternatively, it is also preferred that the plurality of wefts include a plurality of common wefts and one reinforced weft, repeatedly arranged in parallel, and the plurality of warps includes a plurality of common warps and one reinforced warp, repeatedly arranged in parallel, and the common wefts and the common warps are contacted in length direction. More preferably, the reinforced weft and the reinforced warp are colored.

Meanwhile, the weft and the warp may be yarn made by one selected from the group consisting of polyethylene fiber, polypropylene fiber, polyamide fiber, and polyester fiber. Preferably, a coating layer is coated on one or both surfaces of the fabric structure. More preferably, the fabric structure may be used for a waterproof tent, a sheltering cover, fabrics for a temporary tent, an isolating screen in a construction spot.

In another aspect of the invention, there is provided a method for manufacturing a fabric structure, which includes (a) winding a yarn for weft around a corn; (b) winding a predetermined length of the yarn around a drum of a length measuring machine from the corn; (c) storing the yarn wound around the drum by means of air blown out of a balloon breaker; (d) arranging a plurality of warps in a vertical direction so that the warps are alternately waved; (e) delivering the yarn to a nozzle through an exit of the balloon breaker as much as a predetermined length in succession; and (f) delivering the yarn into a gap between the alternately waved warps twice in succession by discharging a pressing liquid through the nozzle together with the yarn, and delivering the yarn twice in succession therethrough with exchanging an alternately waved pattern of the warps, and then repeating this delivering procedure until the fabric structure is completely weaved.

At this time, in the step (d), a plurality of common warps and one colored warp are preferably repeatedly arranged in parallel in a vertical direction, and, in the steps (e) and (f), an additional length measuring machine is preferably provided for delivering a colored yarn, and a colored yarn may be delivered twice in succession after repeating the processes of delivering the yarn twice in succession and then delivering the yarn twice in succession with exchanging the alternatively waved pattern of the common warps and the colored warp predetermined times, and this delivering procedure is repeated until the fabric structure is completely weaved.

Meanwhile, in the step (d), a plurality of common warps and one reinforced warp may be repeatedly arranged in parallel in a vertical direction, and, in the steps (e) and (f), an additional length measuring machine may be provided for delivering a reinforced weft, and a reinforced weft is delivered twice in succession after repeating the processes of delivering the yarn twice in succession and then delivering the yarn twice in succession with exchanging the alternatively waved pattern of the common warps and the reinforced warp predetermined times, and this delivering procedure is repeated until the fabric structure is completely weaved.

The method for manufacturing a fabric structure may further include (g) coating a coating agent on one or both surfaces of the weaved fabric structure; and (h) extrusion-coating the fabric structure with passing through a cooling roll and a pressing roll.

### BRIEF DESCRIPTION OF THE DRAWINGS

Other objects and aspects of the present invention will become apparent from the following description of embodiments with reference to the accompanying drawing in which:

FIG. 1a is a perspective view showing a single yarn;

FIG. 1b is a perspective view showing a double ply structure of yarns whose flat surfaces are contacted;

FIG. 1c is a perspective view showing a double ply structure of yarns whose sides are contacted;

FIG. 2a is a plane view showing a fabric structure according to a preferred embodiment of the present invention;

FIG. 2b is a sectional view taken along the II-II′ line of FIG. 2a;

FIG. 3 is a perspective view showing a fabric structure according to another embodiment of the present invention;

FIG. 4 is a perspective view showing a fabric structure according to still another embodiment of the present invention;

FIG. 5 is a sectional view taken along the V-V′ line of FIG. 4;

FIG. 6 is a perspective view showing a fabric structure according to still another embodiment of the present invention;

FIG. 7 is a schematic view showing a length measuring machine for weaving the fabric structure of FIG. 2; and

FIG. 8 is a schematic view showing a length measuring machine for weaving the fabric structure of FIG. 4.

### DESCRIPTION OF THE PREFERRED EMBODIMENT

Hereinafter, preferred embodiments of the present invention will be described in detail referring to the accompanying drawings.

Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

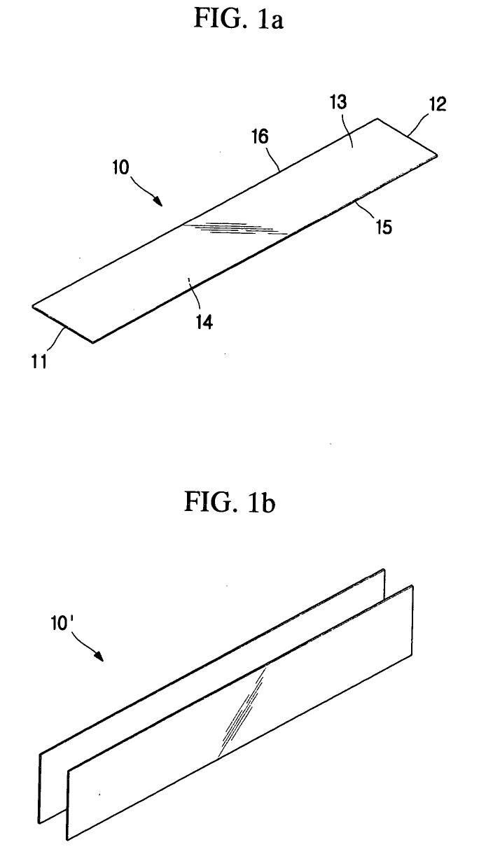

FIG. 1a is a perspective view showing a single yarn 10, and FIGS. 1b and 1c are perspective views showing a double ply structure, which is to be used as a common weft or a common warp.

Referring to FIG. 1a, a single yarn 10 is thin and flat, and it is extended in a length direction. The single yarn 10 has a front side 11, a rear side 12, an upper flat surface 13, a lower flat surface 14, a right end 15, and a left end 16.

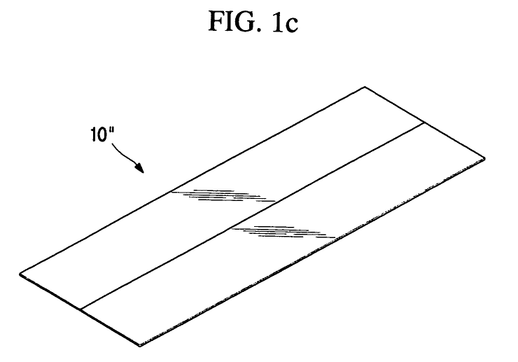

Referring to FIGS. 1b and 1c, weft and warp, which composes a fabric structure 20 (see FIG. 2a) respectively, have a double ply structure so that yarns 10′ and 10″ are contacted with each other with being extended in a length direction. For the double ply structure, the flat surfaces 13 and 14 of the yarns may be contacted with being extended in a length direction as shown in FIG. 1b, and the sides 15 and 16 may also be contacted with being extended in a length direction as shown in FIG. 1c.

FIG. 2a is a plane view showing the fabric structure 20 according to a preferred embodiment of the present invention, and FIG. 2b is a sectional view taken along the II-II′ line of FIG. 2a.

Referring to FIGS. 2a and 2b, each of common wefts 21 and common warps 23, composing the fabric structure 20 of the present invention, has a double ply structure in which at least two yarns are contacted with each other in a length direction. Preferably, sides 15 and 16 (see FIG. 1a) of at least two yarns are contacted with each other in a length direction. The common wefts 21 or the common warps 23 are substantially arranged in parallel, and the common wefts and warps 21 and 23 are weaved so as to be alternately crossed with each other, thereby configuring the fabric structure 20. That is to say, if a first weft and a first warp are weaved to be crossed, an adjacent second weft is weaved with the first warp alternately to be crossed with each other, and then the next weft is alternated again from the second weft and weaved with the first warp to be crossed with each other. This procedure is repeated until the fabric structure is completely weaved. A warp is also weaved in the same way as the weft.

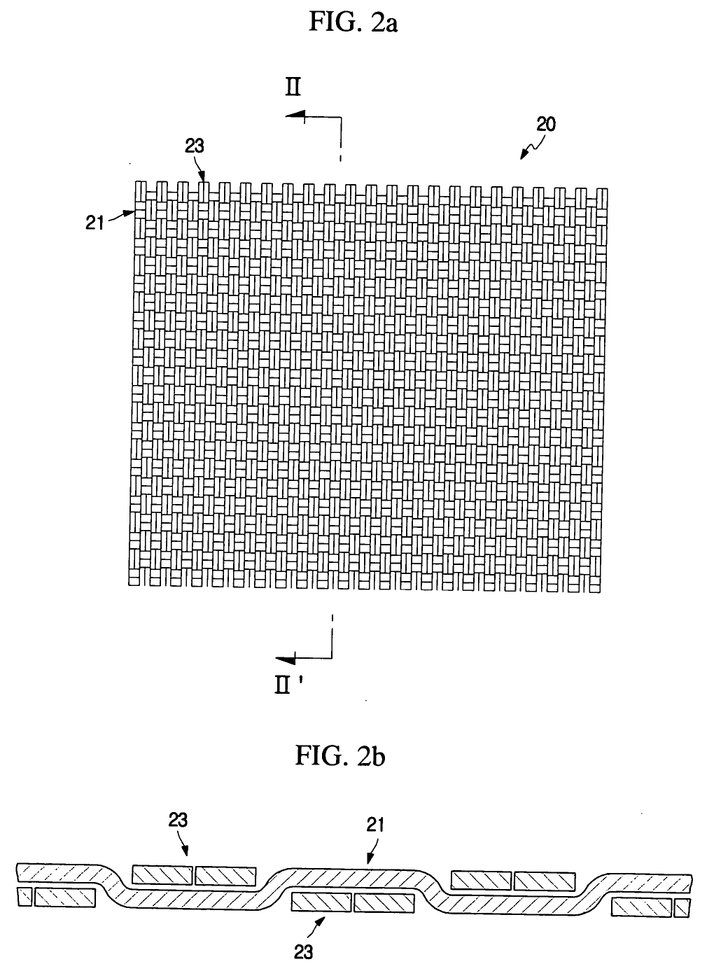

FIG. 3 is a perspective view showing a fabric structure 30 according to another embodiment of the present invention.

Referring to FIG. 3, the fabric structure 30 of this embodiment is configured by repeatedly arranging a plurality of common wefts 31 and one colored weft 35 in parallel, and also repeatedly arranging a plurality of common warps 33 and one colored warp 37 in parallel, and the wefts and warps are weaved to be crossed with each other.

Here, each of the common wefts 31 and the common warps 33 has a double ply structure in which yarns are contacted in a length direction, and preferably sides 15 and 16 (see FIG. 1a) of the yarns are contacted in a length direction. Since the colored wefts 35 and the colored warps 37 are repeatedly inserted and weaved among a plurality of the common wefts 31 and the common warps 33 at regular intervals, rectangular plane patterns are repeatedly formed on the surface of the fabric structure 30. The colored weft 35 and the colored warp 37 may have any color, not limitedly, and preferably have a color capable of meeting the eye easily. Since the repeated rectangular plane patterns are formed on the surface of the fabric structure 30, workers may easily catch sight of it.

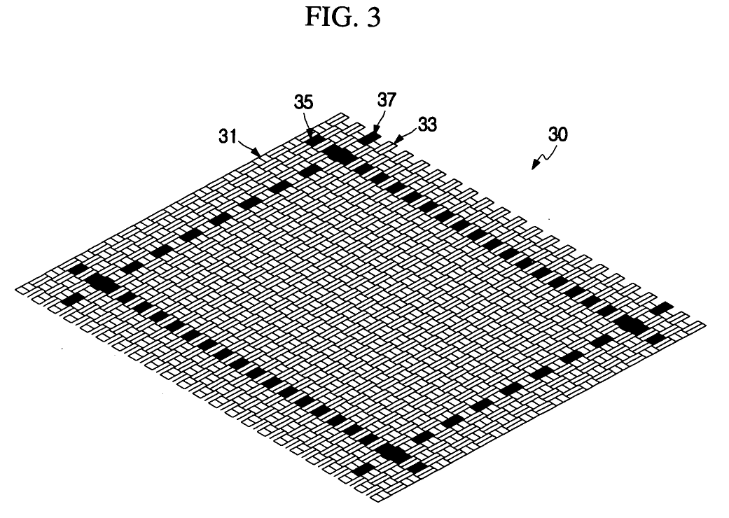

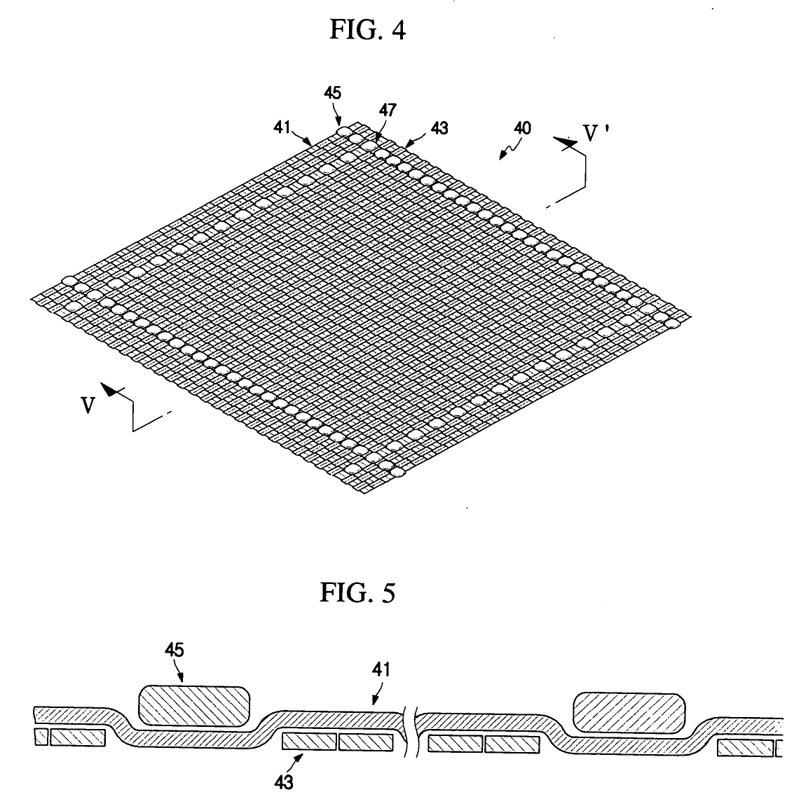

FIG. 4 is a perspective view showing a fabric structure 40 according to still another embodiment of the present invention, and FIG. 5 is a sectional view taken along the V-V′ line of FIG. 4.

Referring to FIGS. 4 and 5, the fabric structure 40 of this embodiment is configured by repeatedly arranging a plurality of common wefts 41 and one reinforced weft 45 in parallel and also repeatedly arranging a plurality of common warps 43 and one reinforced warp 47 in parallel. The arranged wefts and warps are weaved to be crossed with each other.

Here, the terms ‘common weft 41’ and ‘common warp 43’ mean weft and warp having a normal thickness with a double ply structure in which yarns are contacted in a length direction. Preferably, sides 15 and 16 (see FIG. 1a) of the yarns are contacted in the double ply structure. In addition, the reinforced weft 45 means a weft having a thickness relatively larger than the common weft 41, and the reinforced warp 47 similarly means a warp relatively thicker than the common warp 43. Since the reinforced wefts 45 and the reinforced warps 47 are repeatedly inserted and weaved among a plurality of the common wefts 41 and the common warps 43 at regular intervals, protruded rectangular patterns are repeatedly formed on the surface of the fabric structure 40. The repeated protruded rectangular pattern increases a frictional force of the surface of the fabric structure 40, so accidents caused by sliding or the like while a worker is working on the fabric structure 40 may be prevented.

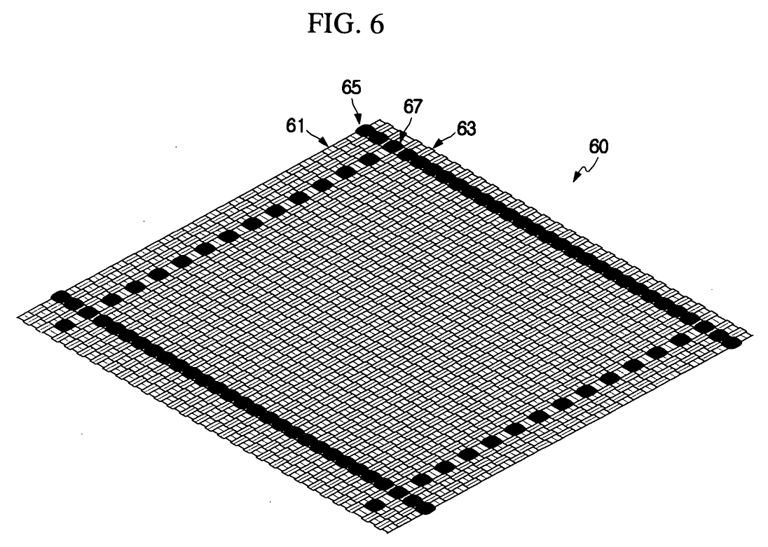

FIG. 6 is a perspective view showing a fabric structure 60 according to still another embodiment of the present invention.

Referring to FIG. 6, the fabric structure 60 of this embodiment is substantially identical to the fabric structure 40 of FIG. 4, except that a reinforced weft 65 and a reinforced warp 67 are colored. The colored reinforced weft and warp 65 and 67 may have any color, not limitedly, and preferably have a color capable of meeting the eye easily. Since the colored protruded rectangular pattern is formed on the surface of the fabric structure 60, a surface friction of the fabric structure 60 is increased, thereby preventing slippery thereon, and workers may easily catch sight of the pattern, thereby improving its impression.

In the fabric structure 20, 30, 40 or 60 according to the present invention, the common wefts 21, 31, 41 and 61 and the common warps 23, 33, 43 and 63 may be made of various materials, preferably polyolefin fiber, more preferably yarns made of one selected from the group consisting of polyethylene fiber, polypropylene fiber, polyamide fiber and polyester fiber.

In addition, a coating agent may be coated on one or both surfaces of the fabric structure 20, 30, 40 or 60, and the fabric structure 20, 30, 40 or 60 coated by the coating agent may be extrusion-coated with passing through a cooling roll and a pressing roll. Material of the coating agent is not limited.

The fabric structure 20, 30, 40 and 60, or the modified fabric structure on one or both surfaces of which are coated by a coating agent, may be preferably used, not limitedly, for a waterproof tent, a sheltering cover, fabrics for a temporary tent, an isolating screen in a construction spot.

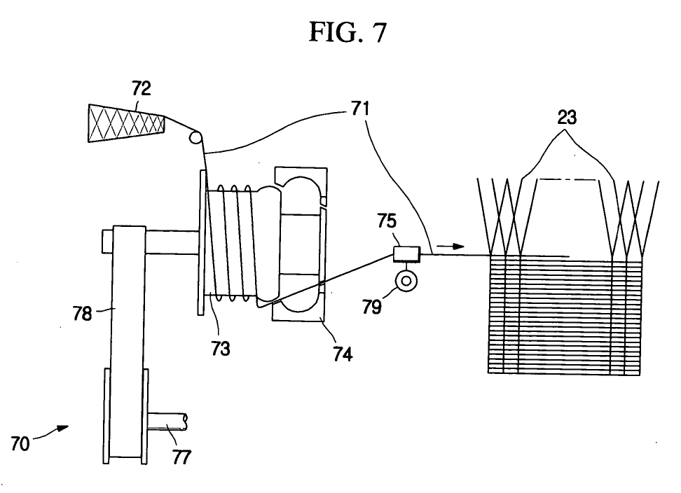

FIG. 7 is a schematic view showing a length measuring machine 70 for weaving the fabric structure of FIG. 2.

Now, a method for manufacturing a fabric structure according to the present invention will be described in detail with reference to FIG. 7.

First, a rotational force of a driving axis 77 rotates a drum 73 through a belt 78, and then a yarn 71 wound around a corn 72 is transferred and wound around the drum 73 of the length measuring machine. In this case, the yarn 71 is cut into a predetermined length suitable for a width of the fabric structure to be weaved, and then wound around the drum 73.

Subsequently, the yarn 71 wound around the drum 73 is stored by means of air blown through a side of a balloon breaker 74.

Then, a plurality of common warps 23 are arranged in a vertical direction so that the warps are alternately waved. The common warp 23 has a double ply structure in which yarns are contacted in a length direction, and preferably sides 15 and 16 (see FIG. 1a) of the yarns are contacted in a length direction.

Subsequently, the yarn 71 is delivered through a gap between the alternately waved common warps 23. The yarn is delivered to a nozzle 75 through an exit of the balloon breaker 74 as much as a predetermined length, and a pressing liquid (not shown) is also discharged through the nozzle 75 together with the yarn 71 by means of a pressure of a pump 79 connected to the nozzle 75 so that the yarn 71 is delivered into the gap between the alternately waved common warps 23. In order to have a double ply structure in which yarns are contacted in a length direction, each weft is configured by delivering a yarn 71 twice in succession, then exchanging the alternative waved pattern of a plurality of the common warps 23 and moving the nozzle 75 as much as an interval between adjacent wefts, and then delivering a yarn 71 twice in succession again. At this time, it is also possible to move the common warps in an opposite direction as much as the same interval, instead of moving the nozzle 75. By repeating the processes of arranging the common warps 23 in an alternately waved pattern and delivering yarns 71 twice in succession, the fabric structure may be weaved.

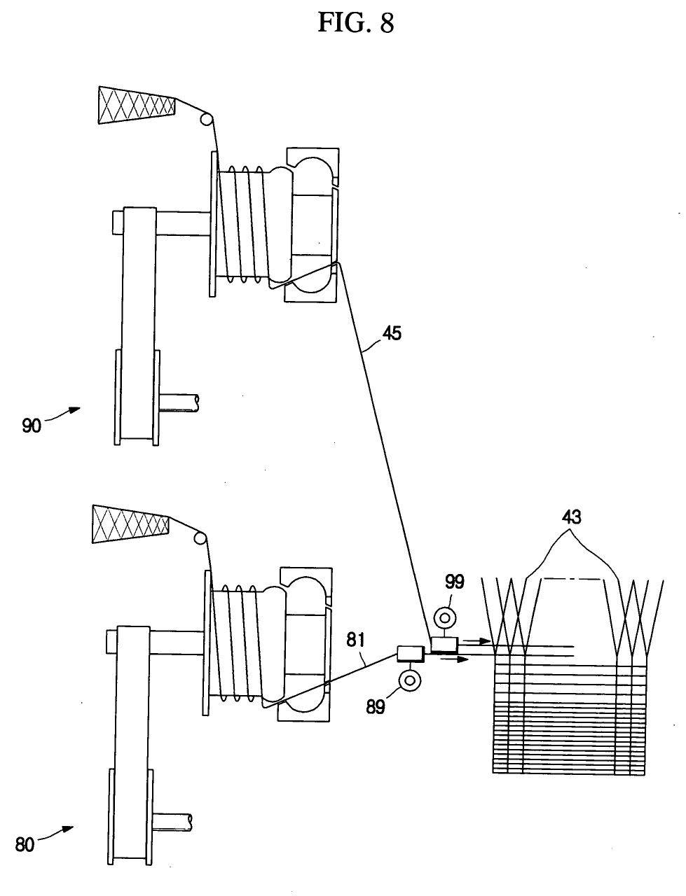

FIG. 8 is a schematic view showing a length measuring machine 80 and an additional length measuring machine 90 for weaving the fabric structure of FIG. 4.

Now, a method for manufacturing a fabric structure according to the present invention is described with reference to FIG. 8. This method is different from the method of FIG. 8 only in the points of the process of arranging a plurality of the warps 43 and the process of delivering yarns 81 and the reinforced weft 45, and the following description is mainly focused on the different points.

First, while a plurality of the common warps 43 are arranged in a vertical direction, one reinforced warp (not shown) is repeatedly arranged together with the common warps 43 so that the common warps 43 and the reinforced wrap are arranged in an alternately waved pattern.

Subsequently, a yarn 81 is delivered into a gap formed between the common warps 43 and the reinforced warp (not shown), alternately waved. The delivering process is identical to that of FIG. 7. That is to say, the processes of delivering yarns 81 twice in succession, then arranging the common warps 43 and the reinforced warp (not shown) so as to exchange their alternately waved pattern, moving the nozzle correspondingly, and then delivering yarns 81 twice in succession again are repeated. After repeating the processes predetermined times, the reinforced weft 45 is delivered by means of the additional length measuring machine 90.

The process of delivering the reinforced weft 45 by using the additional length measuring machine 90 is not so different from that using the length measuring machine 80. However, the additional length measuring machine 90 delivers the reinforced weft 45 relatively thicker than the yarn 81, so a pump 99 of the additional length measuring machine 90 should provide greater pressure than a pump 89 of the length measuring machine 80 for delivering the yarn 81.

Preferably, in this embodiment, the reinforced weft 45 and the reinforced warp 47 (see FIG. 4) may be colored. The color of the reinforced weft 45 and the reinforced warp 47 is not limited, but a color capable of easily meeting the eye is preferred.

In still another embodiment of the present invention, the reinforced weft 45 and the reinforced warp 47 (see FIG. 4) may be substituted with the colored common weft 35 (see FIG. 3) and the colored common warp 37 (see FIG. 3). In this case, a length measuring machine for delivering the colored common weft 35 (see FIG. 3) is additionally needed. If the colored common weft 35 (see FIG. 3) and the colored common warp 37 (see FIG. 3) are inserted at regular intervals and then weaved, repeated rectangular plane patterns may be formed on the surface of the fabric structure. The color of the colored common weft 35 and the colored common warp 37 is not limited, of course, but a color capable of easily meeting the eye is preferred.

Hereinafter, the present invention will be described in more detail with an embodiment. However, the embodiment of the present invention may be modified in various ways, and the present invention should not be interpreted to be limited by the following embodiment. The embodiment of the present invention is provided for those ordinarily skilled in the art to understand the present invention better.

### Embodiment 1

Common wefts and common warps are prepared. Each of the common wefts and the common warps is made of a film with a thickness of 850 deniers, and has a double ply structure in which sides of the films are contacted in a length direction. Here, 1 denier means a thickness of yarn with a length of 450 m and a weight of 0.05 g. Such common wefts and warps are repeatedly arranged in parallel respectively and then weaved into a fabric structure so that the wefts and the warps are crossed with each other. Seven pieces of common wefts and common warps are provided per one inch of the fabric structure, and the fabric structure has a weight of 200 g/m². Tensile strength and tear strength of the weaved fabric structure are shown in the following table 1.

### COMPARATIVE EXAMPLE 1

Each of wefts and warps is made of a single film with a thickness of 850 deniers. Such wefts and warps are repeatedly arranged in parallel respectively, and then weaved into a fabric structure so that the wefts and the warps are crossed with each other. 16 pieces of wefts and 14 pieces of warps are provided per one inch of the fabric structure, and the fabric structure has a weight of 186 g/m². Tensile strength and tear strength of the weaved fabric structure are shown in the following table 1.

TABLE 1

| | Embodiment 1 | Comparative Example 1 |
|---|---|---|
| Tensile Strength (kg) | Weft: 87 | Weft: 70 |
| | Warp: 83 | Warp: 82 |
| Tear Strength (kg) | Weft: 32 | Weft: 14 |
| | Warp: 29 | Warp: 13 |

### Embodiment 2

A fabric structure is made in the same way as the embodiment 1, except that common wefts and common warps of the fabric structure are made of polyester fiber with a thickness of 1000 deniers, and 10 pieces of common wefts and common warps are provided per one inch of the fabric structure. On both surfaces of the fabric structure, PVC is coated. The fabric structure has a weight of 615 g/m². Tensile strength and tear strength of the weaved fabric structure are shown in the following table 2.

### COMPARATIVE EXAMPLE 2

A fabric structure is made in the same way as the comparative example 1, except that common wefts and common warps of the fabric structure are made of polyester fiber with a thickness of 1000 deniers, and 20 pieces of common wefts and common warps are provided per one inch of the fabric structure. On both surfaces of the fabric structure, PVC is coated. The fabric structure has a weight of 610 g/m². Tensile strength and tear strength of the weaved fabric structure are shown in the following table 2.

TABLE 2

| | Embodiment 2 | Comparative Example 2 |
|---|---|---|
| Tensile Strength (kg) | Weft: 186 | Weft: 176 |
| | Warp: 186 | Warp: 181 |
| Tear Strength (kg) | Weft: 40 | Weft: 30 |
| | Warp: 38 | Warp: 33 |

Seeing the results of Tables 1 and 2, it is found that tensile strength and tear strength of the fabric structure manufactured by the method of the present invention are greatly improved rather than those of the comparative examples 1 and 2.

### APPLICABILITY TO THE INDUSTRY

The fabric structure according to the present invention shows beneficial effects as follows.

First, the fabric structure of the present invention may improve tensile strength and tear strength rather than the existing fabrics since each of common wefts and common warps has a double ply structure in which yarns are contacted in a length direction and the common wefts and warps are weaved to be crossed with each other.

Second, the fabric structure of the present invention, whose wefts and warps respectively have a double ply structure in which sides of yarns are contacted, may have a lighter weight per unit area than the conventional fabric whose weft and/or warp has a structure in which surfaces of yarns are contacted to improve mechanical strength. In addition, such a fabric structure of the present invention may be more easily handled and more flexible.

Third, since reinforced wefts and reinforced warps are arranged in parallel among the common wefts and the common warps repeatedly, repeatedly protruded rectangular patterns are formed on the surface of the fabric structure, thereby increasing surface frictional force of the fabric structure. It prevents various accidents caused by slippery surface.

Fourth, since the colored common weft and warp or the colored reinforced weft and warp are repeatedly arranged in parallel among a plurality of common wefts and warps and then weaved into a fabric structure, repeated colored rectangular patterns are formed on the surface of the fabric structure. Thus, it is expected that the repeated colored rectangular patterns may relieve fatigue felt by workers and improve an aesthetic sense for its appearance.

Therefore, if a fabric structure is manufactured according to the method of the present invention, the same effects as the present invention may be obtained.

1. A fabric structure in which a plurality of wefts and warps are weaved to be crossed with each other,
wherein each of common wefts and each of common warps, composing the plurality of wefts and warps, are contacted with each other in a length direction.

2. The fabric structure according to claim 1,
wherein each of the common wefts and the common warps has a double ply structure in which sides of yarns thereof are contacted in a length direction.

3. The fabric structure according to claim 2,
wherein the plurality of wefts include a plurality of common wefts and one colored weft, repeatedly arranged in parallel, and the plurality of warps includes a plurality of common warps and one colored warp, repeatedly arranged in parallel.

4. A fabric structure in which a plurality of wefts and warps are weaved to be crossed with each other,
wherein the plurality of wefts include a plurality of common wefts and one reinforced weft, repeatedly arranged in parallel, and the plurality of warps includes a plurality of common warps and one reinforced warp, repeatedly arranged in parallel,
wherein the common wefts and the common warps are contacted in length direction.

5. The fabric structure according to claim 4,
wherein each of the common wefts and the common warps has a double ply structure in which sides of yarns thereof are contacted in a length direction.

6. The fabric structure according to claim 4, wherein the reinforced weft and the reinforced warp are colored.

7. The fabric structure according to claim 5, wherein the reinforced weft and the reinforced warp are colored.

8. The fabric structure according to claim 1
wherein the weft and the warp are yarn made by one selected from the group consisting of polyethylene fiber, polypropylene fiber, polyamide fiber, and polyester fiber.

9. The fabric structure according to claim 2,
wherein the weft and the warp are yarn made by one selected from the group consisting of polyethylene fiber, polypropylene fiber, polyamide fiber, and polyester fiber.

10. The fabric structure according to claim 3,
wherein the weft and the warp are yarn made by one selected from the group consisting of polyethylene fiber, polypropylene fiber, polyamide fiber, and polyester fiber.

11. The fabric structure according to claim 4,
wherein the weft and the warp are yarn made by one selected from the group consisting of polyethylene fiber, polypropylene fiber, polyamide fiber, and polyester fiber.

12. The fabric structure according to claim 5,
wherein the weft and the warp are yarn made by one selected from the group consisting of polyethylene fiber, polypropylene fiber, polyamide fiber, and polyester fiber.

13. The fabric structure according to claim 6,
wherein the weft and the warp are yarn made by one selected from the group consisting of polyethylene fiber, polypropylene fiber, polyamide fiber, and polyester fiber.

14. The fabric structure according to claim 7,
wherein the weft and the warp are yarn made by one selected from the group consisting of polyethylene fiber, polypropylene fiber, polyamide fiber, and polyester fiber.

15. The fabric structure according to claim 1, wherein a coating layer is coated on one or both surfaces of the fabric structure.

16. The fabric structure according to claim 2, wherein a coating layer is coated on one or both surfaces of the fabric structure.

17. The fabric structure according to claim 3, wherein a coating layer is coated on one or both surfaces of the fabric structure.

18. The fabric structure according to claim 4, wherein a coating layer is coated on one or both surfaces of the fabric structure.

19. The fabric structure according to claim 5, wherein a coating layer is coated on one or both surfaces of the fabric structure.

20. The fabric structure according to claim 6, wherein a coating layer is coated on one or both surfaces of the fabric structure.

21. The fabric structure according to claim 7, wherein a coating layer is coated on one or both surfaces of the fabric structure.

22. The fabric structure according to claim 8, wherein a coating layer is coated on one or both surfaces of the fabric structure.

23. The fabric structure according to claim 9, wherein a coating layer is coated on one or both surfaces of the fabric structure.

24. The fabric structure according to claim 10, wherein a coating layer is coated on one or both surfaces of the fabric structure.

25. The fabric structure according to claim 11, wherein a coating layer is coated on one or both surfaces of the fabric structure.

26. The fabric structure according to claim 12, wherein a coating layer is coated on one or both surfaces of the fabric structure.

27. The fabric structure according to claim 13, wherein a coating layer is coated on one or both surfaces of the fabric structure.

28. The fabric structure according to claim 14, wherein a coating layer is coated on one or both surfaces of the fabric structure.

29. The fabric structure according to claim 1,
wherein the fabric structure is used for a waterproof tent, a sheltering cover, fabrics for a temporary tent, an isolating screen in a construction spot.

30. The fabric structure according to claim 2,
wherein the fabric structure is used for a waterproof tent, a sheltering cover, fabrics for a temporary tent, an isolating screen in a construction spot.

31. The fabric structure according to claim 3,
wherein the fabric structure is used for a waterproof tent, a sheltering cover, fabrics for a temporary tent, an isolating screen in a construction spot.

32. The fabric structure according to claim 4,
wherein the fabric structure is used for a waterproof tent, a sheltering cover, fabrics for a temporary tent, an isolating screen in a construction spot.

33. The fabric structure according to claim 5,
wherein the fabric structure is used for a waterproof tent, a sheltering cover, fabrics for a temporary tent, an isolating screen in a construction spot.

34. The fabric structure according to claim 6,
wherein the fabric structure is used for a waterproof tent, a sheltering cover, fabrics for a temporary tent, an isolating screen in a construction spot.

35. The fabric structure according to claim 7,
wherein the fabric structure is used for a waterproof tent, a sheltering cover, fabrics for a temporary tent, an isolating screen in a construction spot.

36. The fabric structure according to claim 8,
wherein the fabric structure is used for a waterproof tent, a sheltering cover, fabrics for a temporary tent, an isolating screen in a construction spot.

37. The fabric structure according to claim 9,
wherein the fabric structure is used for a waterproof tent, a sheltering cover, fabrics for a temporary tent, an isolating screen in a construction spot.

38. The fabric structure according to claim 10,
wherein the fabric structure is used for a waterproof tent, a sheltering cover, fabrics for a temporary tent, an isolating screen in a construction spot.

39. The fabric structure according to claim 11,
wherein the fabric structure is used for a waterproof tent, a sheltering cover, fabrics for a temporary tent, an isolating screen in a construction spot.

40. The fabric structure according to claim 12,
wherein the fabric structure is used for a waterproof tent, a sheltering cover, fabrics for a temporary tent, an isolating screen in a construction spot.

41. The fabric structure according to claim 13,
wherein the fabric structure is used for a waterproof tent, a sheltering cover, fabrics for a temporary tent, an isolating screen in a construction spot.

42. The fabric structure according to claim 14,
wherein the fabric structure is used for a waterproof tent, a sheltering cover, fabrics for a temporary tent, an isolating screen in a construction spot.

43. The fabric structure according to claim 15,
wherein the fabric structure is used for a waterproof tent, a sheltering cover, fabrics for a temporary tent, an isolating screen in a construction spot.

44. The fabric structure according to claim 16,
wherein the fabric structure is used for a waterproof tent, a sheltering cover, fabrics for a temporary tent, an isolating screen in a construction spot.

45. The fabric structure according to claim 17,
wherein the fabric structure is used for a waterproof tent, a sheltering cover, fabrics for a temporary tent, an isolating screen in a construction spot.

46. The fabric structure according to claim 18,
wherein the fabric structure is used for a waterproof tent, a sheltering cover, fabrics for a temporary tent, an isolating screen in a construction spot.

47. The fabric structure according to claim 19,
wherein the fabric structure is used for a waterproof tent, a sheltering cover, fabrics for a temporary tent, an isolating screen in a construction spot.

48. The fabric structure according to claim 20,
wherein the fabric structure is used for a waterproof tent, a sheltering cover, fabrics for a temporary tent, an isolating screen in a construction spot.

49. The fabric structure according to claim 21,
wherein the fabric structure is used for a waterproof tent, a sheltering cover, fabrics for a temporary tent, an isolating screen in a construction spot.

50. The fabric structure according to claim 22,
wherein the fabric structure is used for a waterproof tent, a sheltering cover, fabrics for a temporary tent, an isolating screen in a construction spot.

51. The fabric structure according to claim 23,
wherein the fabric structure is used for a waterproof tent, a sheltering cover, fabrics for a temporary tent, an isolating screen in a construction spot.

52. The fabric structure according to claim 24,
wherein the fabric structure is used for a waterproof tent, a sheltering cover, fabrics for a temporary tent, an isolating screen in a construction spot.

53. The fabric structure according to claim 25,
wherein the fabric structure is used for a waterproof tent, a sheltering cover, fabrics for a temporary tent, an isolating screen in a construction spot.

54. The fabric structure according to claim 26,
wherein the fabric structure is used for a waterproof tent, a sheltering cover, fabrics for a temporary tent, an isolating screen in a construction spot.

55. The fabric structure according to claim 27,
wherein the fabric structure is used for a waterproof tent, a sheltering cover, fabrics for a temporary tent, an isolating screen in a construction spot.

56. The fabric structure according to claim 28,
wherein the fabric structure is used for a waterproof tent, a sheltering cover, fabrics for a temporary tent, an isolating screen in a construction spot.

57. A method for manufacturing a fabric structure, comprising:
(a) winding a yarn for weft around a corn;
(b) winding a predetermined length of the yarn around a drum of a length measuring machine from the corn;
(c) storing the yarn wound around the drum by means of air blown out of a balloon breaker;
(d) arranging a plurality of warps in a vertical direction so that the warps are alternately waved;
(e) delivering the yarn to a nozzle through an exit of the balloon breaker as much as a predetermined length in succession; and
(f) delivering the yarn into a gap between the alternately waved warps twice in succession by discharging a pressing liquid through the nozzle together with the yarn, and delivering the yarn twice in succession therethrough with exchanging an alternately waved pattern of the warps, and then repeating this delivering procedure until the fabric structure is completely weaved.

58. The method for manufacturing a fabric structure according to claim 57,
wherein, in the step (d), a plurality of common warps and one colored warp are repeatedly arranged in parallel in a vertical direction, and
wherein, in the steps (e) and (f), an additional length measuring machine is provided for delivering a colored yarn, and a colored yarn is delivered twice in succession after repeating the processes of delivering the yarn twice in succession and then delivering the yarn twice in succession with exchanging the alternatively waved pattern of the common warps and the colored warp predetermined times, and this delivering procedure is repeated until the fabric structure is completely weaved.

59. The method for manufacturing a fabric structure according to claim 57,
wherein, in the step (d), a plurality of common warps and one reinforced warp are repeatedly arranged in parallel in a vertical direction, and
wherein, in the steps (e) and (f), an additional length measuring machine is provided for delivering a reinforced weft, and a reinforced weft is delivered twice in succession after repeating the processes of delivering the yarn twice in succession and then delivering the yarn twice in succession with exchanging the alternatively waved pattern of the common warps and the reinforced warp predetermined times, and this delivering procedure is repeated until the fabric structure is completely weaved.

60. The method for manufacturing a fabric structure according to claim 59,
wherein, in the steps (d), (e) and (f), the reinforced warp and the reinforced weft are colored.

61. The method for manufacturing a fabric structure according to claim 57, further comprising:
(g) coating a coating agent on one or both surfaces of the weaved fabric structure; and
(h) extrusion-coating the fabric structure with passing through a cooling roll and a pressing roll.
